(19) United States
(12) Patent Application Publication
(10) Pub. No.: US 2014/0267073 A1
(43) Pub. Date: Sep. 18, 2014

(54) TOUCH PANEL STRUCTURAL AND DISPLAY DEVICE USING TOUCH PANEL

(71) Applicant: TECO NANOTECH CO., LTD., Taoyuan County (TW)

(72) Inventors: Te-Fong CHAN, Taoyuan County (TW); Ding-Kuo DING, Taoyuan County (TW); Cheng-Chieh KAO, Taoyuan County (TW); Yu-Yang CHANG, Taoyuan County (TW); Yao-Zong Chen, Taoyuan County (TW)

(73) Assignee: TECO Nanotech Co., Ltd., Taoyuan County (TW)

(21) Appl. No.: 13/830,675

(22) Filed: Mar. 14, 2013

(51) Int. Cl. G06F 3/041

(52) U.S. Cl. CPC G06F 3/041
USPC 345/173

(57) ABSTRACT

A touch panel comprises: a substrate, a transparent conductive layer and a conductive circuit layer. The transparent conductive layer is formed on a surface of the substrate, and the transparent conductive layer has a touch area and an un-touch area. The un-touch area has a plurality of barrier blocks arranged in a matrix, and the barrier blocks form a plurality of vertical and horizontal barrier slots. The conductive circuit layer is directly distributed on the barrier slots formed by the barrier blocks of the touch area, so as to increase the space to distributing circuits on the conductive circuit layer and save cost to manufacturing.

### BACKGROUND OF THE INVENTION

1. Field of the Invention

The present invention generally relates to a display device, more particularly to a display device that has a transparent touch panel.

2. Description of the Related Art

Accompany with mobile communication devices as mobile phone, navigation system, etc., which performances and versatileness are highly developed, electronic devices equipped with transparent touch panels in front of display devices are increasing. Based on the work principles and transmission media of touch panels, the current touch panels are four kinds of resistive, capacitive, infrared and surface acoustic wave, wherein the capacitive touch panel is broadly applied since its high accuracy, strong anti-jamming capability.

For the structure of a touch panel, a transparent conductive layer is an important factor. Generally speaking, the transparent conductive layer is always an ITO layer, but ITO layer as transparent conductive layer may have the shortcomings of worse mechanical and chemical durability. Further, ITO layer may happen resistor uneven distribution phenomenon so as to cause problems of lower resolution, accuracy, etc.

To figure out aforesaid problems, producers apply Carbon nano tubes to be the transparent conductive layer. The transparent conductive layer of Carbon nano tubes shall use conductive circuits and control circuits to transmit capacitance signals, and hence using Carbon nano tubes may cause the problems of processes and structure. As shown in FIG. 1, while in manufacturing the transparent conductive layer of Carbon nano tubes, a transparent conductive layer 20a is formed on a substrate 10a, the transparent conductive layer 20a is further divided into a touch area 30a and an un-touch area 40a, the transparent conductive layer on the un-touch area 40a will be removed by laser etching or wet etching, or, an isolating layer (not shown in figure) is formed on the un-touch area 40a, and a conductive circuit layer 50 is disposed by way of screen printing in order to electrically connect with an electrode conductive layer 301a of the touch area 30a. Such manufacturing may cause longer manufacturing time and more complicate procedures.

### SUMMARY OF THE INVENTION

The main object of the present invention is to solve the disadvantages of related arts and thus provide a touch panel structure, which is to improve an un-touch area structure of the touch panel, so that a conductive circuit layer is directly distributed on the un-touch area, the conductive circuits on the conductive circuit layer may not be affected by defect conduction caused by barrier blocks (conductive layer) of the un-touch area in order to facilitate the circuit design of the conductive circuit layer and yield rate, and save cost to manufacturing as well.

To reach above object, the touch panel comprises:

a substrate;

a transparent conductive layer, disposed on a surface of the substrate, the transparent conductive layer having a touch area and an un-touch area, the touch area having an electrode conductive layer, the un-touch area having a plurality of barrier blocks, a plurality of barrier slots being among the harrier blocks; and

a conductive circuit layer, disposed on the barrier slots of the un-touch area;

wherein the substrate is made from the group consisted of: transparent plastic and transparent glass;

wherein the electrode conductive layer has a plurality of strip-shaped or lump-shaped positive conductive block and negative conductive block;

wherein the transparent conductive layer is indium tin oxide or carbon nano tube;

wherein the barrier blocks are arranged in a matrix;

wherein the barrier blocks form the plurality of vertical and horizontal barrier slots;

wherein the conductive circuit layer has a plurality of conductive circuits;

wherein the width of the conductive circuit is between 30 to 150 μm;

wherein the conductive circuit layer is a conductive metal material as silver paste;

wherein the line distance between the conductive circuits is larger than the width of each of the vertical and horizontal barrier slots.

To reach above object, a display device provided by the present invention comprises:

a touch panel comprises:

a substrate;

a transparent conductive layer, disposed on a surface of the substrate, the transparent conductive layer having a touch area and an un-touch area, the touch area having an electrode conductive layer, the un-touch area having a plurality of barrier blocks, a plurality of barrier slots being among the barrier blocks; and

a conductive circuit layer, disposed on the barrier slots of the un-touch area;

wherein the substrate is made of: transparent plastic and transparent glass;

wherein the electrode conductive layer has a plurality of strip-shaped or lump-shaped positive conductive block and negative conductive block;

wherein the transparent conductive layer is indium tin oxide or carbon nano tube;

wherein the barrier blocks are arranged in a matrix;

wherein the barrier blocks form the plurality of vertical and horizontal barrier slots;

wherein the conductive circuit layer has a plurality of conductive circuits;

wherein the width of the conductive circuit is between 30 to 150 μm;

wherein the conductive circuit layer is a conductive metal material as silver paste;

wherein the line distance between the conductive circuits is larger than the width of each of the vertical and horizontal barrier slots.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of a touch panel of related arts;

FIG. 2 illustrates manufacturing flow chart of the touch panel of the present invention;

FIG. 3 illustrates a schematic lateral view of a semi-manufactured product of the touch panel of the present invention;

FIG. 4 illustrates a schematic front view of the touch panel of the present invention;

FIG. 5 illustrates a schematic view of forming a touch area and an un-touch area of the touch panel of the present invention;

FIG. 6 illustrates a schematic view of forming the un-touch area on a conductive circuit layer of the touch panel of the present invention; and

FIG. 7 illustrates a schematic view of another embodiment of the present invention.

### DETAILED DESCRIPTION OF THE INVENTION

Following preferred embodiments and figures will be described in detail so as to achieve aforesaid objects.

With references to FIG. 2 to FIG. 6, which illustrate a manufacturing flow chart of the touch panel of the present invention and schematic views of manufacturing steps of the touch panel of the present invention. As shown in figures, the method includes the steps of:

(100) providing a substrate 1, which is made of transparent plastic or transparent glass;

(102) forming a transparent conductive layer 2 on one or two surfaces of the substrate 1, the transparent conductive layer 2 having a touch area 21 and an un-touch area 22, wherein the transparent conductive layer 2 is indium tin oxide (ITO) and oriented carbon nano tube (CNT) in order to let the transparent conductive layer 2 have uniform distribution of electric resistance, further that taking CNT as the transparent conductive layer 2 may let the transparent conductive layer 2 be with a better characteristic of transparent in order to raise resolution and precision of a touch panel and a display device, with the touch panel;

(104) machining the touch area 21 and the un-touch area 22 by way of photolithography etching or laser processing, so as to form an electrode conductive layer 23 on the touch area 21, wherein the electrode conductive layer 23 has a plurality of strip-shaped or lump-shaped positive conductive block 231 and negative conductive block 232, the un-touch area 22 having a plurality of barrier blocks 24 arranged in a matrix and a plurality of vertical and horizontal barrier slots 241 being among the barrier blocks 24;

(106) using the lithography etching to form a conductive circuit layer 3 on the un-touch area 22 after screen printing, sputtering or evaporation, the conductive circuit layer 3 having a plurality of conductive circuits 31, each conductive circuit 31 being on the barrier blocks 24, wherein the conductive circuit layer (3) is a conductive metal material such as silver paste.

For above step (106), a touch panel 10 is formed after the conductive circuit layer 3, the width of the conductive circuit 31 of the touch panel 10 is between 30 to 150 μm, the line distance between the conductive circuits 31 is larger than the width of each of the vertical and horizontal barrier slots 241, therefore even printing the conductive circuits 31 on the barrier blocks 24 may not cause short circuit between two conductive circuits 31.

Since the touch panel 10 has the barrier slots 241 on the un-touch area 22, the neighbor conductive circuits 31 on the un-touch area 22 may not touch to each other. So the present invention has the effect of isolation, and the disadvantages of conductive adverse and short circuit caused by traditional electrode circuits directly formed on the un-touch area 22 may be avoided.

Moreover, the conductive circuits 31 directly distributed on the barrier slots 241 formed by the barrier blocks 24 on the un-touch area 22 may increase the space to distribute circuits on the conductive circuit layer 3 and save cost to manufacturing.

With reference to FIG. 6, it illustrates a schematic view of the touch panel of the present invention. As shown in figure, the touch panel 10 includes a substrate 1, a transparent conductive layer 2 and a conductive circuit layer 3; the substrate 1 is made of transparent plastic and transparent glass; the transparent conductive layer 2 is disposed on a surface or two surfaces of the substrate 1, the transparent conductive layer 2 has a touch area 21 and an un-touch area 22, the touch area 21 has an electrode conductive layer 23, the electrode conductive layer 23 has a plurality of strip or lump positive conductive block 231 and negative conductive block 232, further, the un-touch area 22 has a plurality of barrier blocks 24 arranged in a matrix, a plurality of vertical and horizontal barrier slots 241 are among the barrier blocks 24, wherein the transparent conductive layer 2 is indium tin oxide (ITO) and carbon nano tube (CNT) with coherence in order to let the transparent conductive layer 2 have uniform distribution of electric resistance, further that taking CNT as the transparent conductive layer 2 may let the transparent conductive layer 2 be with a better characteristic of transparent in order to raise resolution and precision of a touch panel and a display device with the touch panel; the conductive circuit layer 3 is disposed on the barrier slots 241 of the un-touch area 22, the conductive circuit layer 3 has a plurality of conductive circuits 31, each conductive circuit 31 is on the barrier slots 241. The width of the conductive circuit 31 is between 30 to 150 μm, the line distance between the conductive circuits 31 is larger than the width of each of the vertical and horizontal barrier slots 241, as shown in figure, the conductive circuit layer 3 is a conductive metal material as silver paste.

Since the touch panel 10 has the barrier slots 241 on the un-touch area 22, the width of the conductive circuit 31 is between 30 to 150 μm, the line distance between the conductive circuits 31 is larger than the width of each of the vertical and horizontal barrier slots 241, the neighbor conductive circuits 31 on the un-touch area 22 may not touch to each other. So the present invention has the effect of isolation, and traditional electrode circuits directly formed on the un-touch area 22 causing the disadvantages of conductive adverse and short circuit may be avoided. More, the conductive circuits 31 directly distributed on the barrier slots 241 formed by the barrier blocks 24 on the un-touch area 22 may increase the space to distribute circuits on the conductive circuit layer 3 and save cost to manufacturing.

With reference to FIG. 7, it illustrates a schematic view of another embodiment of the present invention. As shown in figure, the touch panel 10 in operation is installed between a display screen 201 and a protection layer 202 of a display device 20. User is able to not only see the contents displayed on the display screen 201 through the touch panel 10, but also operate according to figures (not shown in figure) displayed by the display screen 201. That is, while the user slides on the surface of the touch panel 10, the paths of sliding are sensed by the electrode conductive layer 23 of the touch area 21. The sensing signals are transmitted to outside control circuits (not shown in figure) through the conductive circuit layer 3, and therefore the functions shown on the display device 20 can be executed.

Moreover, the positive conductive blocks 231 and the negative conductive blocks 232 of the touch area 21 are disposed on the different surfaces of the substrate 1. For example, the positive conductive blocks 231 are on the front surface of the substrate 1 and the negative conductive blocks 232 are on the back surface of the substrate 1, or the positive conductive blocks 231 and the negative conductive blocks 232 of the touch area 21 are disposed on the different blocks of the substrate 1.

Although the invention has been disclosed and illustrated with reference to particular embodiments, the principles involved are susceptible for use in numerous other embodiments that will be apparent to persons skilled in the art. This invention is therefore, to be limited only as indicated by the scope of the appended claims

What is claimed is:

1. A touch panel (10) comprising:
a substrate (1);
a transparent conductive layer (2), disposed on a surface of the substrate 1, the transparent conductive layer (2) having a touch area (21) and an un-touch area (22), the touch area (21) having an electrode conductive layer (23), the un-touch area (22) having a plurality of barrier blocks (24), a plurality of barrier slots (241) being among the barrier blocks (24); and
a conductive circuit layer (3), disposed on the barrier slots (241) of the un-touch area (22).

2. The touch panel (10) according to claim 1, wherein the substrate (1) is made of transparent plastic or transparent glass.

3. The touch panel (10) according to claim 2, wherein the electrode conductive layer (23) has a plurality of strip-shaped or lump-shaped positive conductive blocks (231) and negative conductive blocks (232).

4. The touch panel (10) according to claim 3, wherein material of the transparent conductive layer (2) is selected from the group consisted of indium tin oxide and carbon nano tube.

5. The touch panel (10) according to claim 4, wherein the barrier blocks (24) are arranged in a matrix.

6. The touch panel (10) according to claim 5, wherein the barrier blocks (24) form the plurality of vertical and horizontal barrier slots (241).

7. The touch panel (10) according to claim 6, wherein the conductive circuit layer (3) has a plurality of conductive circuits (31).

8. The touch panel (10) according to claim 7, wherein the width of the conductive circuit (31) is between 30 to 150 μm.

9. The touch panel (10) according to claim 8, wherein the conductive circuit layer (3) is a conductive metal material.

10. The touch panel (10) according to claim 9, wherein the line distance between the conductive circuits (31) is larger than the width of each of the vertical and horizontal barrier slots (241).

11. A display device (20) comprising:
a touch panel (10) comprising:
a transparent conductive layer (2), disposed on a surface of the substrate (1), the transparent conductive layer (2) having a touch area (21) and an un-touch area (22), the touch area (21) having an electrode conductive layer (23), the un-touch area (22) having a plurality of barrier blocks (24), a plurality of barrier slots (241) being among the barrier blocks (24); and;
a conductive circuit layer 3, disposed on the barrier slots (241) of the un-touch area (22).

12. The display device (20) according to claim 11, wherein the substrate (1) is made of transparent plastic or transparent glass.

13. The display device (20) according to claim 12, wherein the electrode conductive layer (23) has a plurality of strip-shaped or lump-shaped positive conductive blocks (231) and negative conductive blocks (232).

14. The display device (20) according to claim 13, wherein material of the transparent conductive layer (2) is selected from the group consisted of indium tin oxide and carbon nanotube.

15. The display device (20) according to claim 14, wherein the barrier blocks (24) are arranged in a matrix.

16. The display device (20) according to claim 15, wherein the barrier blocks (24) form the plurality of vertical and horizontal barrier slots (241).

17. The display device (20) according to claim 16, wherein the conductive circuit layer (3) has a plurality of conductive circuits (31).

18. The display device (20) according to claim 17, wherein the width of the conductive circuit (31) is between 30 to 150 μm.

19. The display device (2.0) according to claim 18, wherein the conductive circuit layer (3) is a conductive metal material.

20. The display device (20) according to claim 19, wherein the line distance between the conductive circuits (31) is larger than the width of each of the vertical and horizontal bather slots (241).
